(19) United States
(12) Patent Application Publication
(10) Pub. No.: US 2020/0252500 A1
(43) Pub. Date: Aug. 6, 2020

(54) VIBRATION PROBING SYSTEM FOR PROVIDING CONTEXT TO CONTEXT-AWARE MOBILE APPLICATIONS

(71) Applicants: Marcello Giordano, Markham (CA); Wei Li, Markham (CA); Wei Zhou, Richmond Hill (CA); Gaganpreet Singh, Markham (CA)

(72) Inventors: Marcello Giordano, Markham (CA); Wei Li, Markham (CA); Wei Zhou, Richmond Hill (CA); Gaganpreet Singh, Markham (CA)

(21) Appl. No.: 16/775,518

(22) Filed: Jan. 29, 2020

Related U.S. Application Data
(60) Provisional application No. 62/799,580, filed on Jan. 31, 2019.

(51) Int. Cl. H04M 1/725; G01H 17/00; G06N 3/08; G06N 3/04; G06K 9/62

(52) U.S. Cl. CPC H04M 1/72569; G01H 17/00; G06K 9/6256; G06N 3/0472; G06N 3/08

(57) ABSTRACT

A vibration probing system may cause an actuator in a mobile device to vibrate. Unprocessed vibration data sensed by sensors is received by a deep learning-based classifier where a context for the mobile device may be predicted and provided to a context-aware application.

### CROSS-REFERENCE TO RELATED APPLICATIONS

The present application claims priority to U.S. Provisional Patent Application No. 62/799,580, filed Jan. 31, 2019, the contents of which are hereby incorporated herein by reference.

### FIELD

The present application relates generally to context-aware mobile application and, more specifically, to a vibration probing system for providing context to such applications.

### BACKGROUND

Research in the field of context-aware applications for mobile communication devices is increasing. Context is a component that is increasingly taken into account when designing applications for mobile communication devices, such as smartphones. Understanding context and taking advantage of a device being aware of context may be seen as important to the successful design of an interactive application. Gathering context information is dependent upon an ability, on the part of the mobile communication device, to collect and process sensor data from various sources. A Global Positioning System (GPS) receiver, a microphone and a proximity sensor are examples of the various sources that can be used to determine contexts such as a location for the mobile communication device, an activity in which a user of the mobile communication device is participating, a surface on which the mobile communication device is resting or a carrying place in which the mobile communication device is being kept (e.g., a pocket, a bag).

One relatively unexplored area of context detection involves the use of sensor probing techniques to enhance the context detection. Sensor probing techniques may be seen to assist in the gathering of information regarding the user's current situation, where the information is more in-depth than the information available using more common techniques. Sensor probing involves “probing” an environment with a known signal or impulse and recording the response received from the environment via the available sensors. Typical examples of sensor probing include the use of sound echoes to characterize the acoustic properties of a room or a concert hall.

Vibration probing is a special case of sensor probing, in which vibrations from an actuator that generates controlled vibrations, such as a vibration motor or a piezoelectric actuator, are used to “probe” a surface of an object to characterize the mechanical behavior of the surface. Sensors, such as accelerometers that are part of the device that is performing the “probing,” are used to record a response received from the surface. This approach is commonly used to characterize the behavior of acoustic musical instruments, such as guitars or violins. Indeed, this approach may be used to analyze the resonant behavior of the body of an acoustic musical instrument.

In the case of applications executed by a mobile communications device (hereinafter mobile device), vibration probing may be used to enhance context awareness. Vibration probing may enable the mobile device to “probe” its environment. Vibration probing may lead to the detection of, for instance, a type of surface on which the mobile device is resting. That is, the surface on which the mobile device is resting forms part of the environment of the mobile device. Such vibration probing uses the actuator (e.g., vibration motor or piezoelectric actuator), which is embedded in all modern mobile devices (e.g., mobile phones), to “probe” the surface and onboard sensors, such as an accelerometer and a microphone, to record the response received from the surface.

Existing techniques for vibration probing typically require heavy use of processing resources (e.g., at the mobile device) for real-time analysis of vibration data. It would be useful to provide an approach for vibration probing that may be less resource-intensive.

### SUMMARY

Aspects of the present application relate to performing vibration probing on a mobile device using unprocessed vibration data and using a deep neural network that has been trained to predict a context for the unprocessed vibration data. This approach removes the need for complex digital signal processing and data analysis to be performed on the unprocessed vibration data.

Aspects of the present application relate to using vibration probing to unlock user interactions focused on context awareness.

Aspects of the present application enable context-aware notifications. Vibration probing may be used to determine context information such as where the mobile device is being kept. Vibration probing may be used to determine context information such as in which hand the user is holding the mobile device. This context information can be used to provide context-appropriate notifications. This context information can be used to adapt the user interface to the device-holding hand.

In examples described herein, techniques for training a deep learning-based classifier to predict a context of a mobile device, based on unprocessed vibration data, are described. The training of the deep learning-based classifier may be performed online or offline. The deep learning-based classifier trained in such a manner may be used to generate predicted labels indicative of the context of the mobile device, with lower demands on processing resources, compared to existing techniques.

In some examples, label training data samples may be created and added to a database of training data, which may enable data from multiple mobile devices to be pooled together to create a more robust training data set.

In some examples, the present disclosure describes a method including: causing vibration of a mobile device using an actuator of the mobile device; receiving, from a sensor of the mobile device, unprocessed vibration data obtained while the mobile device is vibrating; generating, utilizing a deep learning-based classifier, a label indicative of a context for the mobile device based on the unprocessed vibration data; and transmitting, to a context-aware application executing on the mobile device, the generated label indicative of the context.

In some examples, the present disclosure describes a mobile device including: an actuator; a sensor; a memory storing computer-readable instructions; and a processor. The processor is adapted to execute the computer readable instructions to: cause the actuator to vibrate the mobile device; receive, from the sensor, unprocessed vibration data obtained while the mobile device is vibrating; generate, utilizing a deep learning-based classifier, a label indicative of a context for the mobile device based on the unprocessed vibration data; and transmit, to a context-aware application, the label indicative of the context.

In some examples, the present disclosure describes a computer-readable medium storing instructions that, when executed by a processor in a mobile device, cause the processor to: cause vibration of the mobile device using an actuator of the mobile device; receive, from a sensor of the mobile device, unprocessed vibration data obtained while the mobile device is vibrating; generate, utilizing a deep learning-based classifier, a label indicative of a context for the mobile device based on the unprocessed vibration data; and transmit, to a context-aware application executing on the mobile device, the generated label indicative of the context.

In any of the above examples, receiving the unprocessed vibration data may include receiving the unprocessed vibration data obtained utilizing a microphone as the sensor.

In any of the above examples, receiving the unprocessed vibration data may include receiving the unprocessed vibration data obtained utilizing an accelerometer as the sensor.

In any of the above examples, the deep learning-based classifier may be trained by: transmitting the unprocessed vibration data to a server associated with a database that stores unprocessed vibration signature data with respective stored labels indicative of context; receiving, from the server, a stored label indicative of context that corresponds to the unprocessed vibration data; adding the received stored label to the unprocessed vibration data to generate a labeled training data sample; inserting, into a training dataset, the labeled training data sample; and training the deep learning-based classifier using the training dataset.

In any of the above examples, the deep learning-based classifier may be trained by: causing a user to be prompted for a user-provided label indicative of the context; receiving the user-provided label indicative of the context; adding the user-provided label to the unprocessed vibration data to generate a labeled training data sample; inserting, into a training dataset, the labeled training data sample; and training the deep learning-based classifier using the training dataset.

In any of the above examples, the mobile device may transmit, to a server associated with a database that stores unprocessed vibration signature data with respective stored labels indicative of context, the labeled training data sample.

In any of the above examples, the deep learning-based classifier may be implemented using a deep neural network, the deep neural network including a label generator as an output layer for generating the label.

### BRIEF DESCRIPTION OF THE DRAWINGS

Reference will now be made, by way of example, to the accompanying drawings which show example implementations; and in which:

FIG. 1 illustrates a mobile device and three distinct environments along with respective vibration data signatures;

FIG. 2 schematically illustrates components of the mobile device of FIG. 1 in accordance with aspects of the present application;

FIG. 3 illustrates an example context analysis module executed by the processor of FIG. 2, including a vibration probing sub-module and a learning-based classifier, in accordance with aspects of the present application;

FIG. 4 illustrates a flowchart of an example method carried out by the vibration probing system of FIG. 3 in accordance with aspects of the present application;

FIG. 5 illustrates a flowchart of an example method carried out by the learning-based classifier of FIG. 3 in accordance with aspects of the present application;

FIG. 6 illustrates a flowchart of an example method carried out by the context-aware application of FIG. 3 in accordance with aspects of the present application;

FIG. 7 schematically illustrates how an external system may be used with the mobile device of FIG. 1 for training the learning-based classifier of FIG. 3 in accordance with aspects of the present application;

FIG. 8 illustrates an alternative to the context analysis module of FIG. 3, using a classifier improvement sub-module, in accordance with aspects of the present application;

FIG. 9 illustrates a flowchart of an example method carried out by the learning-based classifier of FIG. 3 in accordance with aspects of the present application; and

FIG. 10 illustrates a flowchart of an example method carried out by the classifier improvement sub-module of FIG. 8 for improving the learning-based classifier in accordance with aspects of the present application.

### DETAILED DESCRIPTION

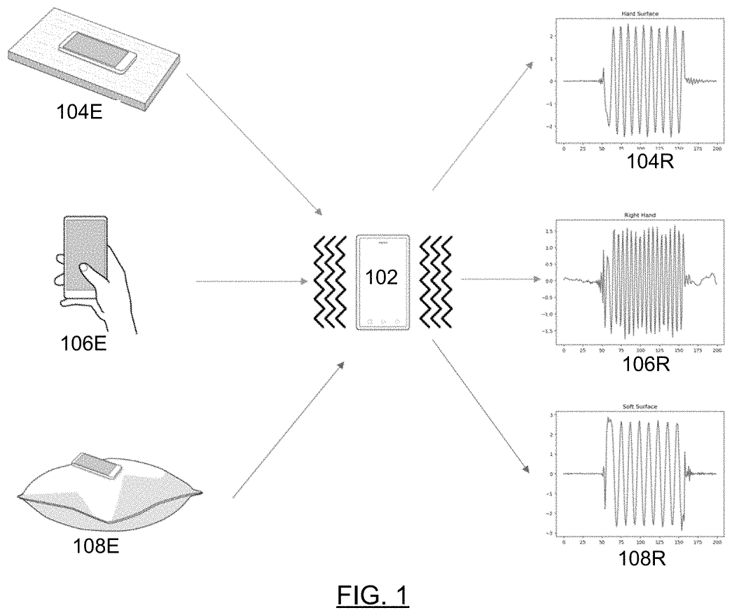

FIG. 1 illustrates a mobile device 102 and three distinct example environments. The first environment 104E is a hard, wooden, tabletop surface. The second environment 106E is a human hand. The third environment 108E is a pillow. FIG. 1 also illustrates example waveform responses corresponding to the illustrated environments. A first waveform response 104R is illustrated corresponding to the first environment 104E. A second waveform response 106R is illustrated corresponding to the second environment 106E. A third waveform response 108R is illustrated corresponding to the third environment 108E.

The waveform responses 104R, 106R, 108R are distinct according to the environment of the mobile device 102. The environment of the mobile device 102 may at least partly define the context of the mobile device 102, in which “context” may refer to any external factor that may affect the behavior or output of the mobile device 102. It follows that a digitized waveform response may be used as additional information to be taken into consideration when the mobile device 102 is determining context.

Currently, in existing vibration probing techniques, processing of vibration data comprising a digitized waveform response, such as a digitized version of the waveform response 104R, 106R, 108R, to determine a context for a mobile device is performed off-line (e.g., not on a mobile device) using a feature extractor and a classifier. In the present disclosure, “off-line” may refer to processing of data by a system external to the mobile device, and typically due to limited processing resources available on the mobile device. The feature extractor detects features (average frequency, amplitude, etc.) in the vibration data (i.e., a digitized waveform response 104R, 106R, 108R) and extracts feature vectors corresponding to the detected features. Subsequently, the classifier receives the extracted feature vectors and classifies the context based on the extracted feature vectors. The processing of the vibration data is performed off-line, due to the significant amount of processing resources required by the feature extractor to extract feature vectors from the vibration data. The requirement for a significant amount of processing resources to process vibration data to extract features and to classify the context makes it a cumbersome process that requires a lot of fine tuning of the feature extractor and of the classifier.

By simplifying the implementation of vibration probing on mobile devices, further applications of vibration probing may be enabled, for example to enable vibration probing to be used for a wider array of context aware application. The further applications include surface-aware ringtones, surface-aware notification and device-holding hand user interface enhancements. A vibration probing system may cause an actuator in the mobile device 102 to vibrate. Unprocessed vibration data sensed by sensors of the mobile device 102 is received by a deep learning-based classifier, which predicts a context for the mobile device 102 and provides the predicted context, in the form of a label, to a context-aware application. For the purposes of the present disclosure, unprocessed vibration data comprises data representative of a raw digitized waveform or data representative of digitized waveform that has been minimally pre-processed (or not pre-processed at all) before being provided to a deep learning-based classifier. Minimally pre-processing the vibration data may refer to only processing the vibration data using simple data cleanup techniques (e.g., removing noise, normalizing the signal, etc.) and not performing processor-intensive analysis such as feature extraction. In some examples, unprocessed vibration data may comprise the raw, recorded vibration data from a sensor. The deep learning-based classifier may include a deep neural network that is trained to learn a model (generally referred to as a neural network model) using a training dataset that includes labeled training samples to minimize a loss function. In one aspect of the present application, the known cross-entropy loss function may be used for the loss function. Each labeled training data sample includes a known unprocessed vibration data (i.e., data representative of known digitized waveforms) and a label indicative of the context for mobile device for the known unprocessed vibration data. It is known that minimizing the loss function may involve use of an optimization algorithm. In one aspect of the present application, the known optimization algorithm called “the Adam Optimization algorithm” may be used in the training of the deep neural network (i.e., optimizing the weights of deep neural network during training of the deep neural network). In another aspect of the present application, a gradient descent algorithm may be used during training of the deep neural network to optimize the weights of the deep neural network. The deep learning-based classifier, during inference (e.g., when the deep neural network is deployed in the model device 102 after training (i.e., after the deep neural network has learned a model to predict a class for the context of the mobile device based on unprocessed vibration data), is configured to receive unprocessed vibration data sensed by sensors, predict a context for the unprocessed vibration data and output a label indicative of the predicted context for the unprocessed vibration data.

Aspects of the present application address the problem of using vibration probing to improve context detection and user interface enhancements in applications executed on mobile devices.

From a technical point of view, it may be considered that the known practice of using a robust vibration probing system that relies on remote embedded systems is computationally expensive in that implementing such a system involves the computation of complex feature vectors on the embedded systems. Aspects of the present application may be seen to obviate most of the complexity found in prior solutions. Specifically, aspects of the present application remove a need to define and compute a vector of time and remove a need to define and compute frequency-domain features to be fed to a classifier. Computing such frequency-domain features can be non-trivial on a mobile platform, especially in real time. Aspects of the present application only require the use of raw and minimally processed vibration data, which is fed to a pre-trained neural network.

From an interaction perspective, the problem of using context cues provided by vibration probing solutions is addressed, by aspects of the present application, to improve context-aware notification settings and a context-adapted user interface. It should be clear to a person of ordinary skill in the art that vibration probing solutions may be only a part of a complex and wide-ranging context determination system that may also employ such elements as GPS receivers, proximity detectors, accelerometers, compasses, microphones, cameras, light sensors, and calendar information when determining context.

Examples in this sense include: surface-aware notifications and ringtone settings; automatic device-holding hand detection and user interface adaptation using vibration probing. In one embodiment, behavior of a game executed on the mobile device may be changed based on a grip detected by vibration probing according to an aspect of the present application.

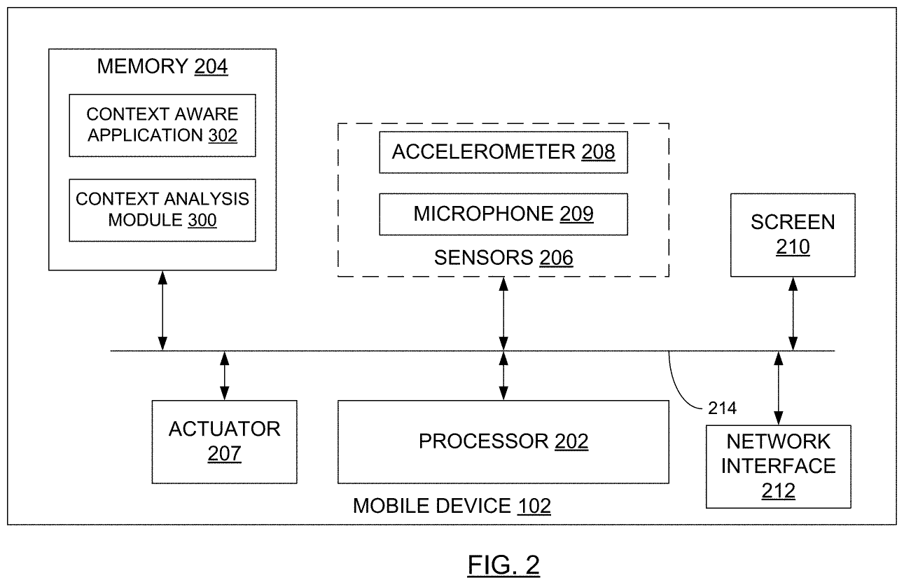

As schematically illustrated in FIG. 2, the mobile device 102 of FIG. 1 includes a processor 202. The processor 202 controls the overall operation of the mobile device 102. The processor 202 is coupled to, and interacts with, various components of the mobile device 102, including a memory 204, a plurality of sensors 206, a display screen 210, and a network interface 212 via a bus 214. Among the plurality of sensors 206 may be an accelerometer 208 and a microphone 209. The mobile device 102 also includes an actuator 207, which may be used to implement a vibration of the mobile device 102. The memory 204 has stored thereon instructions for implementing at least one context aware application 302 and a context analysis module 300, described further below.

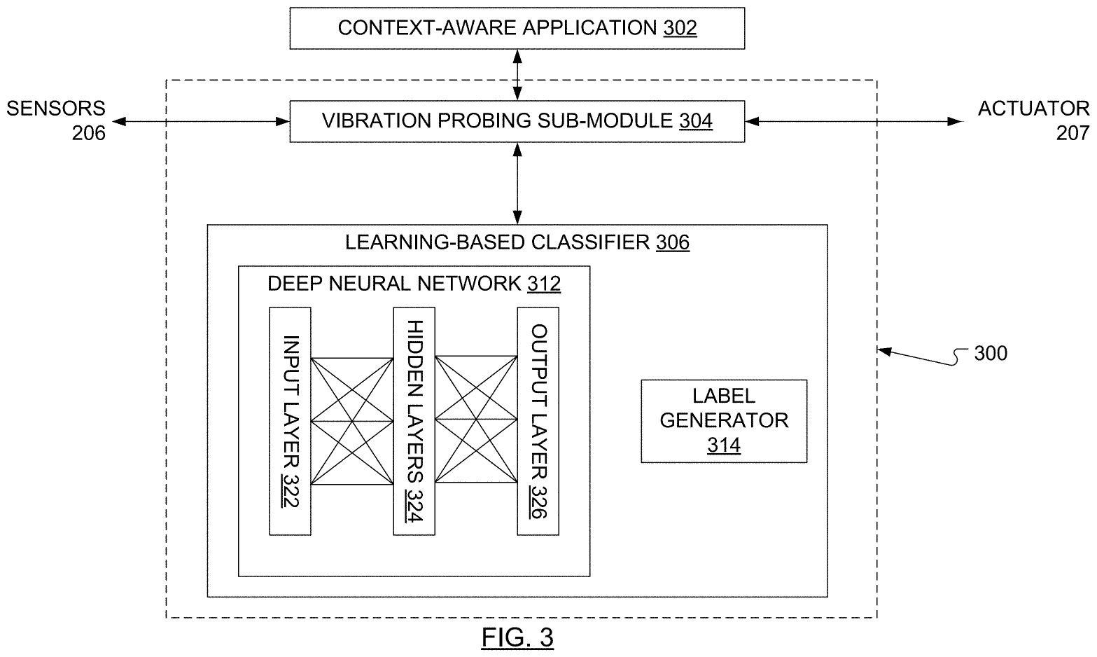

FIG. 3 illustrates details of the context analysis module 300, including how the context analysis module 300 interacts with the context aware application 302 in the memory 204 of the mobile device 102, the actuator 207 and the sensors 206. The context analysis module 300 includes a vibration probing sub-module 304 and a deep learning-based classifier 306, each comprising machine-readable instructions which are executable by the processor 202. In this embodiment, the mobile device 102 is either resting on a surface or being held by a user. The context-aware application 302, when executed by the processor 202, transmits a request to the context analysis module 300 (e.g., to the vibration probing system 304) to obtain a label for the context of the mobile device 102.

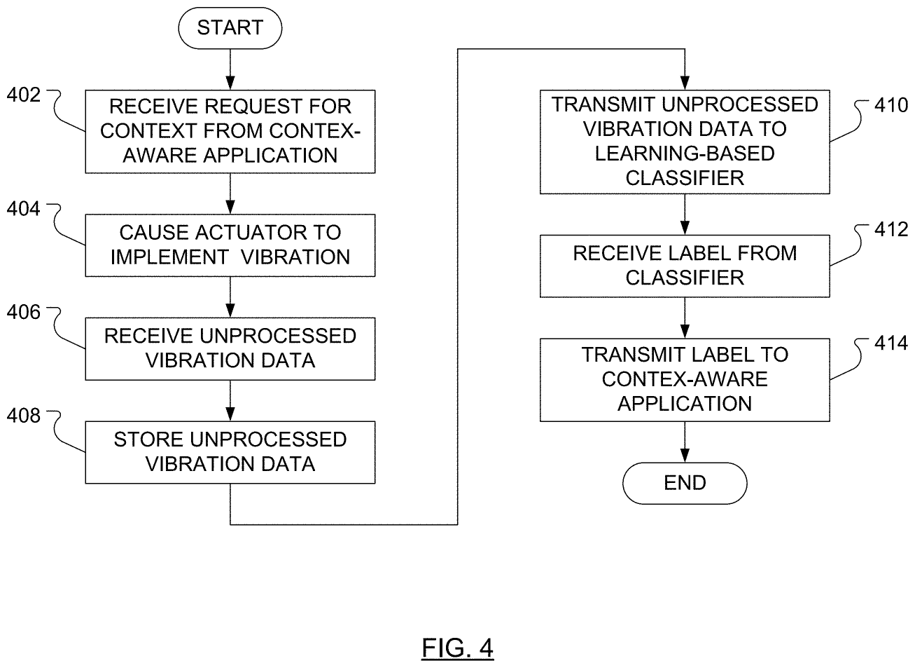

FIG. 4 is a flowchart illustrating example steps in a method carried out by the vibration probing sub-module 304. In response to receiving (step 402) a request for context of the mobile device 102 sent by the context-aware application 302, the vibration probing sub-module 304 interacts with the actuator 207 to cause (step 404) the actuator 207 to implement a vibration having specific vibration parameters. For example, the actuator 207 may implement a 500 ms duration vibration. Other parameters of the vibration, such as amplitude and frequency, may also be selected for the vibration. The vibration probing sub-module 304 may then receive (step 406) unprocessed vibration data from one sensor or multiple sensors among the plurality of sensors 206 of the mobile device 102, such as the accelerometer 208 or the microphone 209. The unprocessed vibration data may be data representative of a digitized waveform response detected by one sensor or multiple sensors among the plurality of sensors 206 of the mobile device 102 (e.g., the accelerometer 208 or from the microphone 209). The vibration probing sub-module 304 may then store (step 408) the received unprocessed vibration data in the memory 204 of the mobile device 102. The vibration probing sub-module 304 may then transmit (step 410) the unprocessed vibration data to the deep learning-based classifier 306. Subsequently, the vibration probing sub-module 304 may receive (step 412), from the deep learning-based classifier 306, a label indicative of context for the mobile device 102. The vibration probing sub-module 304 may then transmit (step 414), to the context-aware application 302, the label indicative of context for the mobile device 102.

Reference is made again to FIG. 3. In aspects of the present application, the deep learning-based classifier 306 includes a deep neural network 312. The deep neural network 312 includes an input layer 322, several hidden layers 324 and an output layer 326. In some embodiments, the deep neural network 312 is a convolutional neural network. The deep neural network 312 may be trained using a training dataset that includes a plurality of labeled data samples. Each labeled data sample includes unprocessed vibration data (i.e., data representative of a known digitized waveform) and metadata that is indicative of a label for the labeled data sample (i.e., a known context of the mobile device for the digitized waveform). The deep neural network 312 may be “trained” using the training dataset to learn a model to predict context of the mobile device 102 based on received unprocessed vibration data while minimizing a loss function such as the known cross-entropy loss function. In some embodiments, the “trained” deep neural network 312 predicts a context for the mobile device 102 and the label generator 314 receives the predicted context for the mobile device 102 and selects a class (or category) from a set of classes (or categories) that corresponds to the predicted context for the mobile device 102. The label generator 314 is configured to generate a label indicative of the selected class (or category) of the mobile device 102 and output the label. In some embodiments, the deep neural network 312 predicts a context for the mobile device 102, selects a class (or category) from a set of classes (or categories) that corresponds to the predicted context for the mobile device 102, and outputs a label indicative of the selected class (or category) of the mobile device 102. The “trained” deep neural network 312 of the deep learning-based classifier 306 may be used, during inference, to predict context based on a new unlabeled data sample comprising unprocessed vibration data received from the vibration probing system 304 (i.e., generate a label indicative of a selected class for the predicted context for the mobile device 102 based on a new unlabeled data sample).

In some embodiments, during inference, the “trained” deep neural network 312 may not be able to predict context based on a new unlabeled data sample that includes unprocessed vibration data received from the vibration probing system 304. In these embodiments, the deep-learning based classifier 306 may use other data received from sensors 206 of the mobile device 102 to determine a context for the mobile device 102 and generate a label indicative of the determined context for the mobile device 102. In this embodiment, the label may be added to the unlabeled data sample as metadata to form a new labeled data sample, and the new labeled data sample may be added to the training dataset. The deep neural network 212 may then be re-trained using the training dataset that includes the new labeled data sample to learn a new model for predicting the context of the mobile device 102.

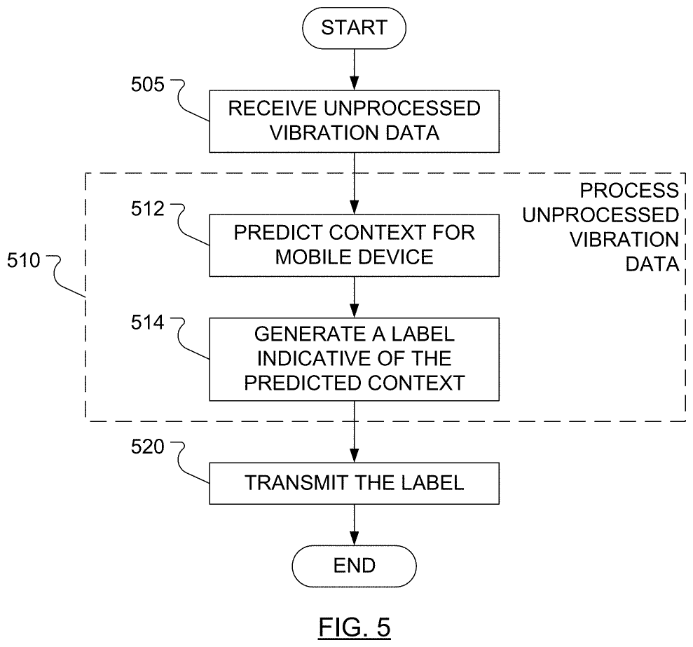

FIG. 5 is a flowchart illustrating example steps in a method carried out by the deep learning-based classifier 306 of FIG. 3. The deep learning-based classifier 306 initially receives (step 505) the unprocessed vibration data transmitted by the vibration probing sub-module 304 in step 410 of the method illustrated in FIG. 4. The deep learning-based classifier 306 processes (step 510) the received unprocessed vibration data using the deep neural network 312 to predict a context for the mobile device 102 based on the received unprocessed vibration data, selects a set of classes (or categories) (e.g., kitchen table, sofa, right hand, etc.) that corresponds to the predicted context for the mobile device 102 and generates a label which is indicative of predicted context for the mobile device 102. The deep learning-based classifier 306 then transmits (step 520), to the vibration probing sub-module 304, the label which is indicative of the selected class (or category) for the mobile device 102.

The processing (step 510) of the received unprocessed vibration data is performed by the deep neural network 312 which predicts (step 512) a context for the mobile device 102 based on the received unprocessed vibration data. Since the output of the deep neural network 312 is likely to be a one-dimensional vector representative of a predicted context, the deep learning-based classifier 306 may include a label generator 314 (see FIG. 3) to handle conversion of the one-dimensional vector representative of the predicted context to a corresponding label which is indicative of the predicted context. In the present disclosure, a label may be any data (e.g., a string, or a set of bits) that would be recognized by the context-aware application 302 as a context of the mobile device 102. Accordingly, the processing (step 510) of the received unprocessed vibration data, by the deep learning-based classifier 306, may be understood to include the label generator 314 which generates (step 514) the label indicative of the predicted context for the mobile device 102 based on the output of the convolutional neural network 312. In some examples, the label generator 314 may be part of the deep neural network 312, for example as the output layer 326 of the deep neural network 312.

The deep neural network 312 may be implemented using TensorFlow, which is an open source machine learning platform. In one aspect of the present application, the deep neural network 312 is a convolution neural network that has an architecture that follows the known LeNet-5-network design, which was described in Y. LeCun, L. Bottou, Y. Bengio and P. Haffner “Gradient-based learning applied to document recognition,” Proceedings of the IEEE, November 1998. The first layer of the convolutional neural network may be implemented as a combination of a one-dimensional (1D) convolutional layer and a max pool layer. The 1D convolutional layer may, for example, have 32 filters of size 9 and stride size of 1, with each of the 32 filters being followed by a rectified linear unit (ReLU). The max pool layer may have pool size 2 and stride size of 2. The second layer of the convolutional neural network may be implemented using the same structure as the first layer. The third layer of the convolutional neural network may be implemented as a fully connected layer using the ReLU activation function and 0.5 dropout. The convolutional neural network may use Softmax and Argmax to produce its output. It is known that Softmax is a function that takes, as input, a vector of K real numbers and normalizes the vector into a probability distribution consisting of K probabilities proportional to the exponentials of the input numbers. Similarly, it is known that Argmax is a function that takes, as input, a vector of K real numbers and produces a categorical output that is the index of the number with the maximum value.

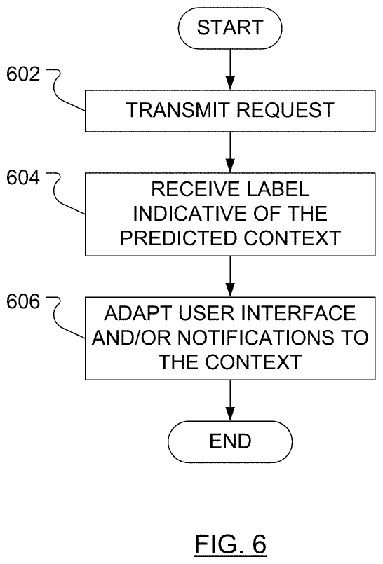

FIG. 6 is a flowchart illustrating example steps of a method carried out by the context-aware application 302. Initially, the context-aware application 302 transmits (step 602) the request for context of the mobile device 102 that is received by the vibration probing sub-module 304 in step 402 (FIG. 4). Subsequently, the context-aware application 302 receives (step 604) the label indicative of the predicted context for the mobile device 102 transmitted by the vibration probing sub-module 304 in step 414 (FIG. 4). The context-aware application 302 may then adapt (step 606) the user interface of the context-aware application 302 to be specific to the predicted context indicated by the label. If the label indicates that the mobile device 102 is being held in the left hand, the user interface may include a dialog box with an interface button that is placed in the lower left-hand corner of the screen (not shown) of the mobile device 102 so that the interface button is easily reached by a left thumb of the user.

Context may be defined as the user's current situation, both in terms of location (in car, at home, at the gym) and activity (working, training, studying, etc.). Upon receiving (step 604) the label indicative of the predicted context of the mobile device 102, the context-aware application 302 executed on the mobile device 102 may autonomously select specific information as being more relevant than other information. Additionally, upon receiving (step 604) the label indicative of the predicted context of the mobile device, the processor 202 may execute machine-readable instructions to recommend new content and decide when to interrupt the user. In some examples, the context-aware application 302 may obtain information from other applications executing on the mobile device 102, in addition to the information received from the context analysis module 300, to further determine the context of the mobile device 102.

In one example, the context-aware application 302 executed on the mobile device 102 may set a ringtone volume level if, for instance, the context-aware application 302 receives information from the context analysis module 300 (using the vibration probing sub-module 304 and the deep learning-based classifier 306) that the current context for the mobile device 102 is “lying flat on an office desk” and the mobile device 102 further receives information from a calendar application that indicates the user is in a meeting.

In another example, the context-aware application 302 executed on the mobile device 102 may set a back light intensity level for the display screen 210 to a minimum when receiving a call if the label indicative of the predicted context of the mobile device 102 indicates that the mobile device 102 is on a hard surface and the context-aware application 302 further receives information from a clock application that indicates the time as late at night (thus indicating that the mobile device 102 is likely on a nightstand beside the user's bed).

In a further example, users can select their own notifications according to the label indicative of the predicted context of the mobile device 102, e.g., the context-aware application 302 executed on the mobile device 102 may place the mobile device 102 in silent mode upon receiving, from the context analysis module 300, a label indicating that the mobile device 102 is on a soft surface (e.g., a bed). The user may select a different ringtone for use responsive to receiving a label indicating that the mobile device 102 is on a hard surface (e.g., a kitchen counter or on a living room table).

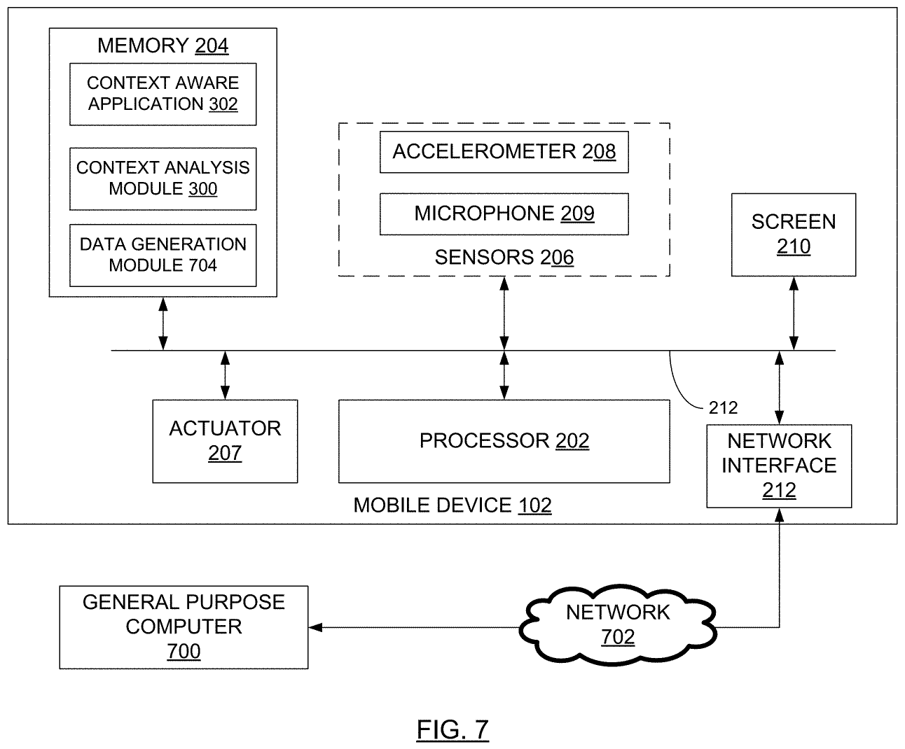

As mentioned above, training of the deep neural network 312 of the deep learning-based classifier 306 involves utilizing a training dataset that includes labeled data samples. FIG. 7 illustrates the mobile device 102 interacting with a general purpose computer 700 (hereinafter referred to a computer 700) via a network 702. The mobile device 102 includes a data generation module 704 that is stored in memory 204 of the mobile device 102. The data generation module 704 is configured to generate labeled data samples and add the generated labeled data samples to a training dataset. The training dataset may be stored in memory 204 of the mobile device 102 and transmitted to the computer 700, via the network interface 212 and the network 702. The computer 700 may receive the training data set including the labeled data samples, train the deep neural network 312 to learn a model to predict the context of the mobile device 102, generate machine-executable code 708 of the “trained” deep neural network 312. After the deep neural network 312 is trained at the computer 700, 312, the computer 700 may transmit the machine-executable code 708 of the deep neural network 312 to the mobile device 102 via the network 702 and the network interface 210 for storage in memory 204 of the mobile device 102 for execution by the processor 202 of the mobile device 102.

Transmitting the training dataset to the computer 700 may include transmitting individual labeled training data samples to the computer 700, or periodically as a batch of labeled data samples.

In some embodiments, the computer 700 may be a virtual machine provided by a cloud computing service provider, a physical machine (i.e., a physical computing device), a cluster of computing devices, or a distributed computing system.

The data generation module 704 may be configured to prompt a user, using a user interface rendered on the display screen 210, to manipulate a user interface rendered, for example, by the data generation module 704 on the display screen 210 of the mobile device 102 to provide a user-provided label for a context for the mobile device 102. The user may then place the mobile device 102 in the context. The data generation module 704 may then cause the actuator 207 to implement a sequence of 500 ms duration vibrations. The data generation module 704 receives (see step 406, FIG. 4) unprocessed vibration data from the plurality of sensors 206. The data generation module 704 generates a labeled data sample by adding the user-provided label (e.g., as metadata) to the unprocessed vibration data, and adds the labeled data sample to the training data set 704. The training data set 704 may be stored in the memory 204 and subsequently communicated to the general purpose computer 700.

The machine-executable code 708 includes the parameters (also known as weights) for the layers of the deep neural network 312. The machine-executable code 708 may be subsequently stored in the memory 204 of the mobile device 102. The computer 700 may also subsequently arrange the storage of the received unprocessed vibration data locally in association with the user-provided label.

At the computer 700, the training dataset, generated at the request of the data generation module 704, may be used to train the deep neural network 312 to learn a model to predict a context of the mobile device 102 so that, upon completion of the training (e.g., during inference), the “trained” deep neural network 312 may be deployed in the mobile device 102 (i.e., stored as the machine-readable code 708 in the memory 204). In some examples, the label generator 314 is part of the deep neural network 312 (e.g., as the output layer 326) and training the deep neural network 312 results in a model that generates a label indicative of a selected class (or category) corresponding to a predicted context for the mobile device 102. During inference, execution of the “trained” deep learning-based classifier 306 by the processor 202 allows for processing of unprocessed vibration data to generate a label indicative of a selected class (or category) corresponding to a predicted context for the mobile device 102. Consequently, the deep learning-based classifier 306 will be able to discriminate the present context for the mobile device 102 from other known contexts.

Conveniently, the use, in the context analysis module 300 (see FIG. 3), of unprocessed vibration data in combination with deep learning, as represented by the deep learning-based classifier 306, means that complex data processing, at the mobile device 102, is significantly reduced, if not eliminated. Machine-readable instructions of the trained deep neural network 312 may, in some examples, be executed by a dedicated Neural Processing Unit (NPU), such as a tensor processing unit (TPU). The plurality of sensors 206 and the NPU are known to be present on most modern mobile telecommunication devices. The use of the deep learning-based classifier 306 may, by reducing the amount of processing resources required, enable the context analysis module 300 to be more frequently used by various different context-aware applications 302, to provide a greater variety of context-specific user interactions.

Aspects of the present application may be seen to enable more context-specific user interactions, such delivery of more context-specific content, both in terms of adapted notifications and adapted user interface elements. These new ways to deliver content may be seen to be facilitated by less processor-intensive vibration probing, as disclosed in the present application. It may be considered that context-awareness would be very difficult to achieve without using real-time vibration probing, as disclosed in the present application.

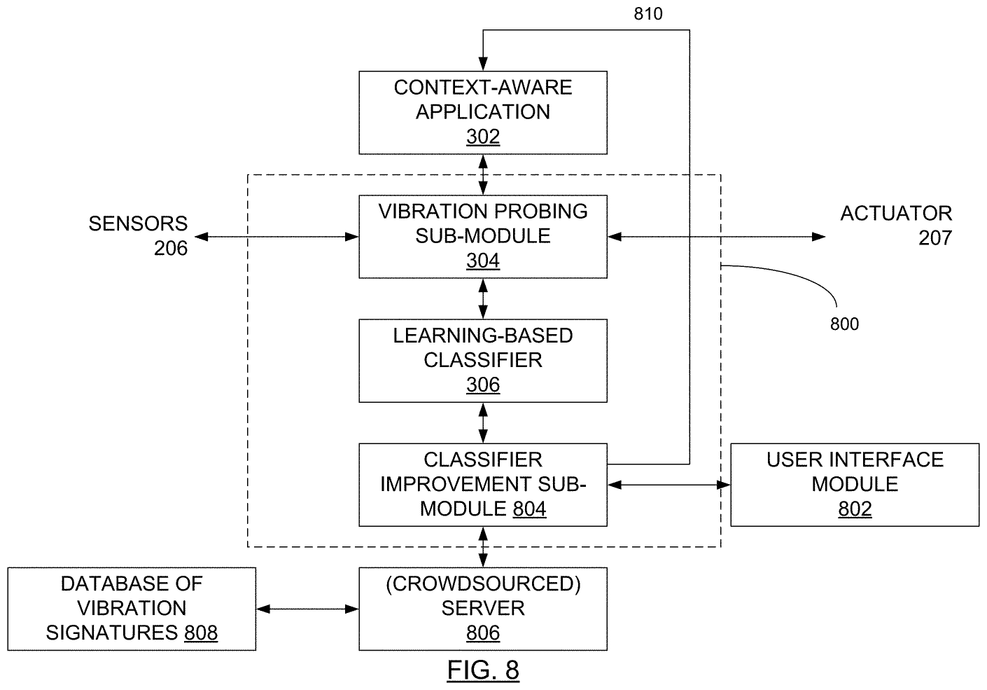

In another aspect of the present application, training of the deep-neural network 312 occurs without making use of the computer 700 for training. Indeed, training may occur as a consequence of operation (e.g., part of regular user interaction with the mobile device 102). An alternative context analysis module 800 is illustrated in FIG. 8. The context analysis module 800 includes a vibration probing module 304, a learning-based classifier 306. The process of continuously improving the deep neural network 312 may be called “on-line learning.”

An initial deep learning-based classifier 306 is provided to the processor 202. The initial deep learning-based classifier 306 includes a pre-trained deep neural network 312 and the label generator 314. Pre-training deep neural network 312 involves training the deep neural network 312 using a training dataset included labeled training data samples, as described above with respect to training the deep neural network 312. The initial deep learning-based classifier 306 is to be able to generate a label indicative of a selected class (or category) corresponding to a predicted context for the mobile device 102 from an initial set of classes or categories that each correspond to a different context for the mobile device 102.

The method illustrated in FIG. 4 for the vibration probing system 304 applies in the alternative context analysis module 800 illustrated in FIG. 8. The context-aware application 302 initiates the training of the deep neural network 312 by transmitting a request for a context label from the vibration probing sub-module 304.

In response to receiving (step 402) the request, the vibration probing sub-module 304 interacts with the actuator 207 to cause (step 404) the actuator 207 to implement a vibration according to specific parameters (e.g., a specific duration of time, at specific frequency and amplitude). The vibration probing sub-module 304 may then receive (step 406) unprocessed vibration data from the sensors 206 (e.g., accelerometer 208 and the microphone 209). The vibration probing sub-module 304 may then record (step 408) the received unprocessed vibration data. The vibration probing system 304 may then transmit (step 410) the unprocessed vibration data to the learning-based classifier 306.

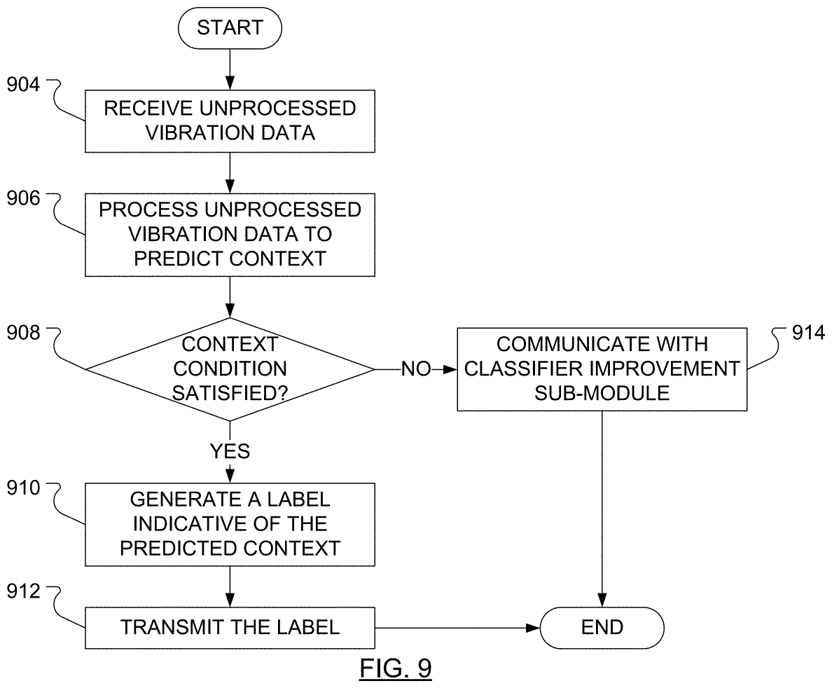

FIG. 9 is a flowchart illustrating example steps in a method carried out by the deep learning-based classifier 306 in the alternative context analysis module 800. The deep learning-based classifier 306 receives (step 904) the unprocessed vibration data. The deep learning-based classifier 306 uses the trained deep neural network 312 to predict (step 906) a context for the mobile device 102 based on the received unprocessed vibration data. The deep learning-based classifier 306 determines (step 908) whether the context has been sufficiently predicted. This determining may be implemented by defining a “confidence score” for the context for the mobile device 102 predicted in step 906. In instances wherein the output layer 326 of the deep neural network 312 includes the Softmax function, the confidence score for the predicted context may be seen to be built in to the output of the Softmax function. If the confidence score exceeds a threshold, a context condition may be considered to have been satisfied. This confidence score is used to trigger the classifier improvement sub-module 804 of the alternative context analysis module 800 to generate a request for user feedback, which may be presented to a user via a user interface module 802 (which may be implemented using instructions stored in the memory 204), when the confidence score is below the threshold.

Upon determining (step 908) that the context condition has been satisfied, the deep learning-based classifier 306 may use the label generator 314 to generate (step 910) a label indicative of the predicted context for the mobile device 102. The deep learning-based classifier 306 may then transmit (step 912), to the context-aware application 302 via the vibration probing system 304, the generated label.

The data generation module of the mobile device generated label may be added (e.g., as metadata) to the unprocessed vibration data to form a labeled training data sample, and the labeled training data sample may be added to a training data set for training the deep neural network 312.

Upon determining (step 908) that the context condition has not been satisfied, the deep learning-based classifier 306 communicates (step 914) with the classifier improvement sub-module 804 (see FIG. 8) to request a label for the unprocessed vibration data.

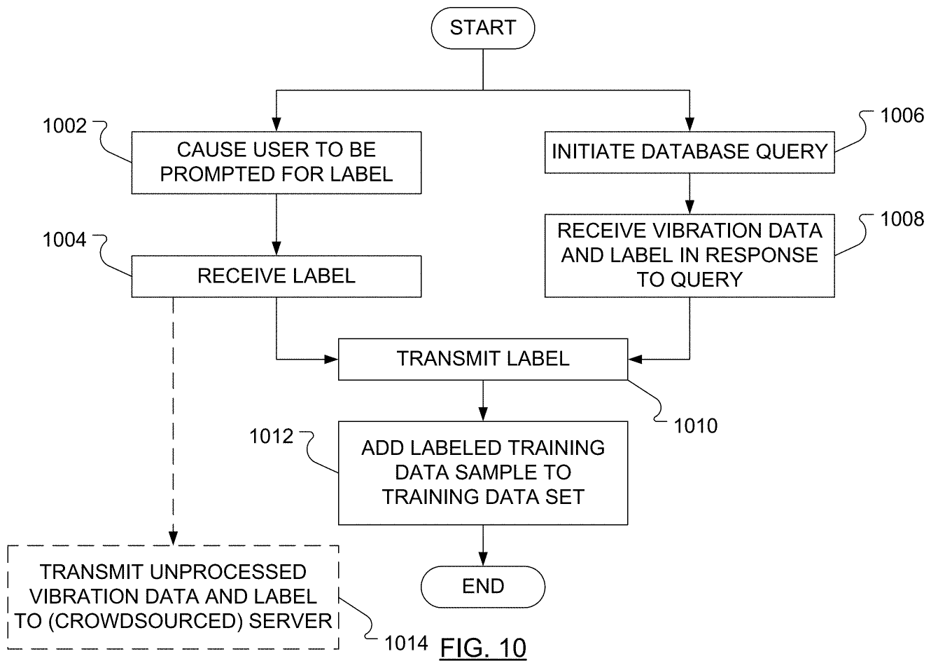

FIG. 10 is a flowchart illustrates example steps in a method of generating labeled training data samples for training the deep learning-based classifier 306. The classifier improvement sub-module 804 may communicate (step 1002) with the user interface module 802 (see FIG. 8) to cause the user interface module 802 to prompt the user to provide a user-provided label for the context for the unprocessed vibration data. Upon receiving (step 1004), from the user interface module 802, the user-provided label for the context, the classifier improvement sub-module 804 may transmit (step 1010) the user-provided label to the context-aware application 302. The classifier improvement sub-module 804 may transmit (step 1010) the user-provided label to the context-aware application 302 directly, via a pathway 810, or indirectly, via the deep learning-based classifier 306 and the vibration probing sub-module 304. The classifier improvement sub-module 804 may then add the user-provided label to the unprocessed vibration data to generate a labeled training data sample, and add (step 1012) the labeled training data sample to the training data set 704 (see FIG. 7) for training the deep neural network 312.

Instead of, or in addition to, communicating (step 1002) with the user interface module 802, the classifier improvement sub-module 804 may initiate (step 1006) a query of an external database 808 (see FIG. 8) that associates each vibration signature of a plurality vibration signatures with a respective label indicative of a context. More precisely, the classifier improvement sub-module 804 may transmit, to a server 806 (see FIG. 8), which may be a crowdsourced server, the unprocessed vibration data. The server 806 may determine whether the unprocessed vibration data matches a vibration signature in the database 808. Upon determining that there is a matching vibration signature for the received unprocessed vibration data in the database 808, the server 806 may transmit, to the classifier improvement sub-module 804, a database-provided label indicative of a context associated, in the database 808, with the matching vibration data along with the matching vibration data.

Upon receiving (step 1008) the database-provided label indicative of the context and the matching vibration data, the classifier improvement sub-module 804 may transmit (step 1010) the database-provided label indicative of the context to the context-aware application 302. The classifier improvement sub-module 804 may transmit (step 1010) the database-provided label directly, via a pathway 810, or indirectly, via the deep learning-based classifier 306 and the vibration probing sub-module 304. The classifier improvement sub-module 804 may then add the database-provided label to the unprocessed vibration data to generate a labeled training data sample, and add (step 1012) the labeled training data sample to the training data set 704 (see FIG. 7) for training the deep neural network 312.

Optionally, the classifier improvement sub-module 804 may transmit (step 1014) the unprocessed vibration data and the associated user-provided label indicative of context to the server 806 for insertion into the database 808. Conveniently, if unprocessed vibration data associated with the user-provided label is not already in the database 808, it may be considered that the database 808 will be improved by the insertion.

Conveniently, the use, in the alternative context analysis module 800 (see FIG. 8), of unprocessed vibration data from the plurality of sensors 206 to improve the learning-based classifier 306 may be seen to enhance future context predictions (step 906). By using the database 808, to which other mobile devices may contribute, a probability of accurately predicting a given context may be increased. The shared vibration signature knowledge base (the database 808) may be considered to significantly improve overall context prediction rates.

Notably, vibration probing, as disclosed in the present application, could be actively used by the user to probe surfaces and record information about the material or physical properties of the probed surface. This physical property information could be stored, for example, as metadata in a photograph of the probed surface. This physical property information could also be associated, in a database, with an entry specific to the probed surface, as a system similar to QR codes, but based on a vibration data signature captured by a vibration probing system rather than a pattern captured by camera.

Vibration probing could also be an important component for a “Tactile Internet,” which may be considered to be part of forthcoming evolutionary changes to the Internet of Things, enabled by the availability of so-called “5G” communications. Vibration probing could be used to characterize the physical properties of objects and surfaces. Such characterization may be streamed, in real time, over 5G networks to augment communication between two remote parties.

According to an aspect of the present disclosure, there is provided a method of providing a label indicative of a context for a mobile device. The method includes causing vibration of the mobile device using an actuator of the mobile device, receiving, from a sensor of the mobile device, unprocessed vibration data obtained while the mobile device is vibrating, processing the unprocessed vibration data, utilizing a deep learning-based classifier, to generate the label indicative of the context for the mobile device and transmitting, to a context-aware application executing on the mobile device, the generated label indicative of the context. In other aspects of the present application, a mobile device with a processor is provided for carrying out this method and a computer-readable medium is provided for storing instructions that, when executed by a processor in a mobile device, cause the processor to carry out this method.

In an example 1, there is described a method of determining a context for a device, the method including: causing vibration of the device using an actuator of the device; receiving, from a sensor of the device, unprocessed vibration data obtained while the device is vibrating; classifying the unprocessed vibration data utilizing a deep learning-based classier to obtain the context from the vibration data; and transmitting, to a context-aware application executed on the device, the context.

In an example 2, there is described the method of example 1 wherein the sensor comprises a microphone.

In an example 3, there is described the method of example 1 wherein the sensor comprises an accelerometer.

In an example 4, there is described the method of example 1 wherein the deep learning-based classifier comprises a deep convolutional neural network.

In an example 5, there is described a device including: an actuator; a sensor; a memory storing computer-readable instructions; and a processor adapted to execute the computer readable instructions to: cause the actuator to vibrate the device; receive, from the sensor, unprocessed vibration data obtained while the device is vibrating; classify, utilizing a deep learning-based classifier, the unprocessed vibration data to obtain the context from the vibration data; and transmit, to a context-aware application, the context.

In an example 6, there is described the mobile device of example 5 wherein the sensor comprises a microphone.

In an example 7, there is described the mobile device of example 5 wherein the sensor comprises an accelerometer.

In an example 8, there is described the mobile device of example 5 wherein the deep learning-based classifier comprises a deep convolutional neural network.

In an example 9, there is described a method of generating a surface-aware notification, the method including: transmitting a request for environment information; receiving an indication of a context, the context associated with a surface; and adapting a user interface to generate a notification specific to the surface.

In an example 10, there is described a method of adapting a user interface of a specific hand, the method including: transmitting a request for environment information; receiving an indication of a context, the context associated with the specific hand; and adapting a user interface to generate a dialog associated to the specific hand.

In an example 11, there is described a method of improving a context database, the method including: receiving vibration data associated with a response to arranged vibrations of a device on a surface; determining, based on the vibration data, a context; determining a confidence score to associate with the context; determining that the confidence score does not exceed a threshold; causing a user to be prompted for an identity of the surface; receiving the identity of the surface; and transmitting, to a server associated with the context database, the identity of the surface and the vibration data.

In an example 12, there is described a method of improving a learning-based classifier, the method including: receiving vibration data associated with a response to arranged vibrations of a device on a surface; determining, based on the received vibration data, a context; determining a confidence score to associate with the context; determining that the confidence score does not exceed a threshold; transmitting the received vibration data to a server associated with a database that stores vibration data with respective indications of context; receiving, from the server, an indication of a context that corresponds to the received vibration data; and inserting, into the learning-based classifier, the received indication of context in association with the received vibration data.

In an example 13, there is described a method of vibration probing, the method including: receiving vibration data associated with a response to arranged vibrations of a device on a surface; arranging display of a prompt capture of an image of the surface; receiving the image of the surface; and storing, in metadata associated with the image, the vibration data.

The above-described implementations of the present application are intended to be examples only. Alterations, modifications and variations may be effected to the particular implementations by those skilled in the art without departing from the scope of the application, which is defined by the claims appended hereto.

What is claimed is:

1. A method comprising:
causing vibration of a mobile device using an actuator of the mobile device;
receiving, from a sensor of the mobile device, unprocessed vibration data obtained while the mobile device is vibrating;
generating, utilizing a deep learning-based classifier, a label indicative of a predicted context for the mobile device based on the unprocessed vibration data; and
transmitting, to a context-aware application executing on the mobile device, the generated label indicative of the context.

2. The method of claim 1 wherein receiving the unprocessed vibration data comprises receiving the unprocessed vibration data obtained utilizing a microphone as the sensor.

3. The method of claim 1 wherein receiving the unprocessed vibration data comprises receiving the unprocessed vibration data obtained utilizing an accelerometer as the sensor.

4. The method of claim 1 wherein generating comprises predicting utilizing a model learned by a deep neural network of the deep-learning based classifier, a class from among a plurality of classes for the context of the mobile device based on the unprocessed vibration.

5. The method of claim 4 wherein generating further comprises generating, using a label generator of the deep-learning based classifier the label indicative of a context for the mobile device based on the predicted class for the context of the mobile device.

6. The method of claim 4 further comprising training the deep neural network to learn the model using a training dataset comprising labeled data samples, wherein each label data sample in the training data set comprises unprocessed vibration data and a label indicative of the context of the mobile device associated with the unprocessed data sample.

7. The method of claim 6, further comprising:
transmitting the unprocessed vibration data to a server associated with a database that stores unprocessed vibration data with respective stored labels indicative of context;
receiving, from the server, a stored label indicative of context that corresponds to the unprocessed vibration data;
generating a new labeled training data sample comprising the unprocessed data sample and the received stored label;
inserting, into the training dataset, the labeled training data sample; and
re-training the deep neural network to learn the model using the training dataset.

8. The method of claim 4 further comprising training the deep learning-based classifier by:
causing a user to be prompted for a user-provided label indicative of the context;
receiving the user-provided label indicative of the context;
adding the user-provided label to the unprocessed vibration data to generate a labeled training data sample;
inserting, into a training dataset comprising labeled training data samples, the labeled training data sample; and
training the deep neural network to learn the model using the training dataset.

9. The method of claim 5, further comprising:
transmitting, to a server associated with a database that stores unprocessed vibration signature data with respective stored labels indicative of context, the labeled training data sample.

10. The method of claim 1 wherein the deep learning-based classifier is implemented using a deep neural network, the deep neural network including a label generator as an output layer for generating the label.

11. A mobile device comprising:
an actuator;
a sensor;
a memory storing computer-readable instructions;
a processor adapted to execute the computer readable instructions to:
cause the actuator to vibrate the mobile device;
receive, from the sensor, unprocessed vibration data obtained while the mobile device is vibrating;
generate, utilizing a deep learning-based classifier, a label indicative of a predicted context for the mobile device based on the unprocessed vibration data; and
transmit, to a context-aware application, the label indicative of the context.

12. The mobile device of claim 8 wherein the sensor comprises a microphone.

13. The mobile device of claim 8 wherein the sensor comprises an accelerometer.

14. mobile device of claim 8 wherein the processor is further adapted to execute the computer readable instructions to train the deep learning-based classifier by:
transmitting the unprocessed vibration data to a server associated with a database that stores unprocessed vibration signature data with respective stored labels indicative of context;
receiving, from the server, a stored label indicative of context that corresponds to unprocessed vibration signature data matching the unprocessed vibration data;
adding the received stored label to the unprocessed vibration data to generate a labeled training data sample;
inserting, into a training dataset, the labeled training data sample; and
training the deep learning-based classifier using the training dataset.

15. The mobile device of claim 8 wherein the processor is further adapted to execute the computer readable instructions to train the deep learning-based classifier by:
causing a user to be prompted for a user-provided label indicative of the context;
receiving the user-provided label indicative of the context;
adding the user-provided label to the unprocessed vibration data to generate a labeled training data sample;
inserting, into a training dataset, the labeled training data sample; and
training the deep learning-based classifier using the training dataset;
transmitting, to a server associated with the context database, the user-provided label indicative of the context and the unprocessed vibration data.

16. The mobile device of claim 12 wherein the processor is further adapted to execute the computer readable instructions to:
transmit, to a server associated with a database that stores unprocessed vibration signature data with respective stored labels indicative of context, the labeled training data sample.

17. The mobile device of claim 8 wherein the deep learning-based classifier is implemented using a deep neural network, the deep neural network including a label generator as an output layer for generating the label.

18. A computer-readable medium storing instructions that, when executed by a processor in a mobile device, cause the processor to:
cause vibration of the mobile device using an actuator of the mobile device;
receive, from a sensor of the mobile device, unprocessed vibration data obtained while the mobile device is vibrating;
generate, utilizing a deep learning-based classifier, a label indicative of a predicted context for the mobile device based on the unprocessed vibration data; and
transmit, to a context-aware application executing on the mobile device, the generated label indicative of the context.

19. The computer-readable medium of claim 15 wherein the instructions cause the processor to receive the unprocessed vibration data by causing the processor to receive the unprocessed vibration data obtained utilizing a microphone as the sensor.

20. The computer-readable medium of claim 15 wherein the instructions cause the processor to receive the unprocessed vibration data by causing the processor to receive the unprocessed vibration data obtained utilizing an accelerometer as the sensor.
